(19) United States
(12) Patent Application Publication
(10) Pub. No.: US 2012/0056433 A1
(43) Pub. Date: Mar. 8, 2012

(54) TECHNIQUES FOR THE EFFICIENT GENERATION OF ELECTRIC CURRENT BY TRANSLATION OF FORCE THROUGH HYDRAULIC COUPLING

(75) Inventor: Jason Boyd, Highgate (AU)

(73) Assignee: Intium Technologies Pty Ltd, Western Australia (AU)

(21) Appl. No.: 13/202,701

(22) PCT Filed: Feb. 16, 2010
(86) PCT No.: PCT/AU2010/000163

§ 371 Date: Oct. 31, 2011

Related U.S. Application Data
(60) Provisional application No. 61/154,405, filed on Feb. 22, 2009.

(51) Int. Cl. H02N 11/00

(52) U.S. Cl. 290/54

(57) ABSTRACT

Techniques for efficient generation of electric current from force remote from the generation apparatus and where the operative force for the generation apparatus may be readily directed through hydraulic coupling from the force due to the mass of vehicles acting on a surface to operate the moving component member of a linear induction generator. Optimally hydraulic fluid is made to act directly on a movable magnetic member within a linear induction generator to cause the generation of electric current in conductor windings when the magnetic force from a permanently magnetised member of the generator is caused to be focussed through the conductor windings by the position of alignment between the movable magnetic member and other parts of the fixed magnetic structure.

### BACKGROUND OF THE INVENTION

1. Field of the Invention

The invention relates to the efficient translation of force from vehicular traffic due to gravity and transferred through optimised hydraulic coupling to apparatus which generates electric current and where said apparatus is optimally arranged for operation by hydraulic means.

2. Background Art

Each document, reference, patent application or patent cited in this text is expressly incorporated herein in their entirety by reference, which means that it should be read and considered by the reader as part of this, text. That the document, reference, patent application, or patent cited in this text is not repeated in this text is merely for reasons of conciseness.

The following discussion of the background to the invention is intended to facilitate an understanding of the present invention only It should be appreciated that the discussion is not an acknowledgement or admission that any of the material referred to was published, known or part of the common general knowledge of the person skilled in the art in any jurisdiction as at the priority date of the invention.

Little has been done in practice to translate force through hydraulic coupling to achieve the generation of electric current.

There are no known commercial examples of this type of force translation in use presently or in the past.

Prior attempts to translate forces include the work of Galich, U.S. Pat. No. 6,172,426 which discloses a system having a platform exerting pressure onto a fluid filled bladder, and whereby the fluid is compressed by the force received on the platform by the weight of vehicular traffic, and so driven out of the bladder and collected under pressure in an accumulator vessel, and thus stored until a pre-determined pressure is achieved whereupon the fluid is released to flow through to and drive a generator apparatus in order to generate electricity.

Prior proposals exist to translate forces from vehicular traffic to operate electric generators; however, all so far proposed suffer from excess complexity, great cost of deployment, difficulty in prompt relocation as required, excess conversion losses due to multiple conversion steps between the original form of energy and a subsequent form (say from kinetic to potential), then to a storage phase, often another conversion phase and finally an output as readily usable energy.

Invariably, such examples of prior art suffer from considerable mechanical losses and rapid wear of mechanism parts.

It is against this background that the present invention has been developed.

### SUMMARY OF THE INVENTION

The present invention seeks to overcome, or at least ameliorate, one or more of the deficiencies of the prior art mentioned above, or to provide the consumer with a useful or commercial choice.

According to a first broad aspect of the present invention, there is provided an, apparatus for generating an electric current comprising:

a hollow chamber having a first end and a second end;

an inner core member located within the hollow chamber and movable axially along the hollow chamber;

a conductive coil arranged about the hollow chamber,

wherein the first end of the hollow chamber is configured to receive fluid for acting on the core member to cause the core member to move axially along the hollow chamber thereby inducing an electric current within the conductive coil.

Preferably, the inner core member is a permanent magnet.

Preferably, the apparatus further comprises an outer fixed magnetic structure about the hollow chamber.

Preferably, the fixed magnetic structure comprises a permanent magnetically charged member and a magnetically permeable coupling member arranged about the hollow chamber.

Preferably, the conductive coil, comprises a first conductive coil and a second conductive coil, the first conductive coil is arranged about the outer magnetic structure and the second conductive coil is arranged between the hollow chamber and the magnetically permeable couple member.

Preferably, the second end comprises a spring component for applying a restoring force to the inner core member when the inner core member is caused to move towards the second end by the fluid.

Alternatively, the second end is adapted to receive fluid for acting on the inner core member to cause the inner core member to move axially along the hollow chamber thereby inducing an electric current within the conductive coil.

Preferably, the first and second ends are configured to receive the fluid alternately such that the fluid act alternately on opposing ends of the inner core member thereby causing the inner core member to move back and forth between the first and second ends of the hollow chamber.

Preferably, the first end comprises a housing for accumulating and controlling the volume of the fluid directed to the inner core member.

Preferably, the hollow member comprises a first blocking member disposed at one of the first and second ends for preventing the inner core member from moving beyond said one of the first and second ends.

Preferably, the hollow member comprises a second blocking member disposed at the other one of first and second ends for preventing the inner core member from moving beyond said other one of the first and second ends.

Preferably, the blocking member is in the form of a ring.

Preferably, the apparatus further comprises a vent in communication with the hollow chamber for equalising pressure therein with the atmosphere.

Preferably, the apparatus further comprises one or more conduits containing fluid therein, wherein said one or more conduits are in fluid communication with the first end.

Preferably, the apparatus further comprises one or more conduits containing fluid therein, wherein said one or more conduits are in fluid communication with the second end.

Preferably, said one or more conduits are resilient, and the inner core member is caused to move axially along the hollow chamber when one or more conduits are compressed at a portion thereof thereby causing fluid in said one or more conduits to flow.

Preferably, the fluid acts directly on the inner core member to cause it to move axially along the hollow chamber.

Preferably, said one or more conduits configured to be compressed by wheels of a vehicle as the vehicle travels over said one or more conduits.

Preferably, the inner core member is made of a stainless steel having a copper coating.

Preferably, the inner conductive coil is made of copper wire.

Preferably, the permanent magnetically charged member is made of a high strength magnetic alloy.

Preferably, the magnetic alloy is Neodymium, Iron and Boron (NdFeB).

According to a second broad aspect of the present invention, there is provided a method of generating an electric current with an apparatus, the apparatus comprising:

a hollow chamber having a first end and a second end,

an inner core member located within the hollow chamber and movable axially along the hollow chamber, and

a conductive coil arranged about the hollow chamber,

the method comprising:

receiving fluid at the first end for acting on the inner core member for causing the inner core member to move axially along the hollow chamber thereby inducing an electric current within the conductive coil.

Preferably, the inner core member is a permanent magnet.

Preferably, the apparatus further comprises an outer fixed magnetic structure about the hollow chamber.

Preferably, the fixed magnetic structure comprises a permanent magnetically charged memberland a magnetically permeable coupling member arranged about the hollow chamber.

Preferably, the conductive coil comprises a first conductive coil and a second conductive coil, the first conductive coil is arranged about the outer magnetic structure and the second conductive coil is arranged between the hollow chamber and the magnetically permeable couple member.

Preferably, the second end comprises a spring component, the method further comprising applying a restoring force to the inner core member when the inner core member is caused to move towards the second end by the fluid.

Alternatively, the method further comprises receiving fluid, at the second end for acting on the inner core member to cause the inner core member to move axially along the hollow chamber thereby inducing an electric current within the conductive coil.

Preferably, the method further comprises configuring the first and second ends to receive the fluid alternately such that the fluid act alternately on opposing ends of the inner core member thereby causing the inner core member to move back and forth between the first and second ends of the hollow chamber.

Preferably, the first end comprises a housing, the method further comprising accumulating and controlling the volume of the fluid directed to the inner core member.

Preferably, the hollow member comprises a first blocking member disposed at one of the first and second ends, the method further comprising using the first blocking member to prevent the inner core member from moving beyond said one of the first and second ends.

Preferably, the hollow member comprises a second blocking member disposed at the other one of first and second ends, the method further comprises using the second blocking member to prevent the inner core member from moving beyond said other one of the first and second ends.

Preferably, the blocking member is in the form of a ring.

Preferably, the apparatus further comprises a vent in communication with the hollow chamber, the method further comprising equalising pressure in the hollow chamber with the atmosphere.

Preferably, the method further comprises arranging one or more conduits containing fluid therein to be in fluid communication with the first end.

Preferably, the method further comprises arranging one or more conduits containing fluid therein to be in fluid communication with the second end.

Preferably, said one or more conduits are resilient, the method further comprising compressing one or more conduits at a portion thereon to cause fluid in said one or more conduits to flow thereby causing the inner core member to move axially along the hollow chamber.

Preferably, the fluid acts directly on the inner core member to cause it to move axially along the hollow chamber.

Preferably, the method further comprises compressing said one or more conduits by wheels of a vehicle as the vehicle travels over said one or more conduits.

Preferably, the inner core member is made of a stainless steel having a copper coating.

Preferably, the inner conductive coil is made of copper wire.

Preferably, the permanent magnetically charged member is made of a high strength magnetic alloy.

Preferably, the magnetic alloy is. Neodymium, Iron and Boron (NdFeB).

According to a third broad aspect of the present invention, there is provided an apparatus for generating an electric current comprising:

a hollow chamber having a first end and a second end;

an inner core member located within the hollow chamber and movable axially along the hollow chamber; and

a conductive coil arranged about the hollow chamber,

wherein the first end of the hollow chamber is configured to receive fluid for acting on the core member to cause the core member to move axially along the hollow chamber thereby inducing an electric current within the conductive coil, and

the hollow member comprises a first blocking member disposed at one of the first and second ends for preventing the inner core member from moving beyond said one of the first and second ends.

According to a fourth broad aspect of the present invention, there is provided an apparatus for generating an electric current comprising:

a hollow chamber having a first end and a second end;

an inner core member located within the hollow chamber and movable axially along the hollow chamber; and

a conductive coil arranged about the hollow chamber,

wherein the first end of the hollow chamber is configured to receive fluid for acting on the core member to cause the core member to move axially along the hollow chamber thereby inducing an electric current within the conductive coil, and

wherein the apparatus further comprises a vent in communication with the hollow chamber for equalising pressure therein with the atmosphere.

According to a fifth broad aspect of the present invention, there is provided a method of generating an electric current with an apparatus, the apparatus comprising:

a hollow chamber having a first end and a second end,

an inner core member located within the hollow chamber and movable axially along the hollow chamber, and

a conductive coil arranged about the hollow chamber,

the method comprising:

receiving fluid at the first end for acting on the inner core member for causing the inner core member to move axially along the hollow chamber thereby inducing an electric current within the conductive coil,

wherein the hollow member comprises a first blocking member disposed at one of the first and second ends, the method further comprising using the first blocking member to prevent the inner core member from moving beyond said one of the first and second ends.

According to a sixth broad aspect of the present invention, there is provided a method of generating an electric current with an apparatus, the apparatus comprising:

a hollow chamber having a first end and a second end,

an inner core member located within the hollow chamber and movable axially along the hollow chamber, and

a conductive coil arranged about the hollow chamber,

the method comprising:

receiving fluid at the first end for acting on the inner core member for causing the inner core member to move axially along the hollow chamber thereby inducing an electric current within the conductive coil,

wherein the apparatus further comprises a vent in communication with the hollow chamber, the method further comprising equalising pressure in the hollow chamber with the atmosphere.

An embodiment of the present invention is directed to apparatus configured optimally for the generation of electrical current by the efficient translation of mechanical force directed to said generating apparatus where the source of mechanical force is remote to the generation apparatus and where the force is hydraulically coupled to the operative member components of the generation apparatus. Optimally force may be transferred from a remote source to an operative apparatus by connection through a fluid and where the operative apparatus is specifically designed to be operated by fluid pressure.

Another embodiment of the present invention is directed to an optimally configured electric current generator which is in the form of a linear induction generator having an outer fixed magnetic structure; an inner movable magnetic core member, a guide sleeve between the inner and outer magnetic components which forms a chamber for the containment of hydraulic fluid, at least one coil of conducting wire around the fixed magnetic structure externally and at least one coil of wire inside the fixed magnetic structure but outside the guide sleeve chamber as well as a necessary coupling interface, seals and pressure venting outlets to enable the inner magnetic member to be pushed along the guide sleeve by hydraulic fluid entering the chamber from one end and optionally a spring component at the opposite end of the movable core member from the input force so as to apply a restoring force to the movable member.

In one embodiment the invention is directed to an apparatus which generates electric current due to the principles of electro-magnetic induction as the forces due to magnetic flux are brought to focus through windings of conducting wire because of the controlled movement of an inner magnetic member with respect to the fixed magnetic structure and the coils of conducting wire and where the operative force acting on the movable magnetic core member is derived from hydraulic fluid action directly on one end of that member.

In yet another embodiment the apparatus is advantageously configured for bidirectional force input from anti-phase pulsed pressurised hydraulic fluid made to act alternately on either end of the core operating member by means of duplicating the configuration of elements (208), and (212) at both ends of the liner membrane (202), and deleting the elements (205), (207), and (209). A bi-directional force input arrangement functions with synchronised anti-phase input forces and as such does not require the function of the spring member. (209).

In a preferred embodiment the whole of the apparatus is constructed with all components disposed in concentric relationship as shown in FIG. 1 and the input force transferred to the hydraulic fluid used to operate the electric current generation apparatus is obtained from the downward pressure exerted by motor vehicles moving across a suitable structure containing a plurality of fluid conduits where the force from the vehicles due to gravity causes compression of the conduits containing the fluid and the fluid is caused to move along the conduits and transfer the force to the generation apparatus.

### BRIEF DESCRIPTION OF THE DRAWINGS

Embodiment(s) of the present invention will now be described, by way of example only, with reference to the accompanying drawing, in which:

FIG. 1 shows a lateral cross-section view of an exemplary apparatus according to an embodiment of the present invention with both inner and outer conductor windings about a fixed magnetic structure where the magnetic force from a permanent magnet within that structure is focussed through the conductor windings by the positioning of a movable magnetic core member in order to induce electric current in the conductor windings.

### DETAILED DESCRIPTION OF THE INVENTION

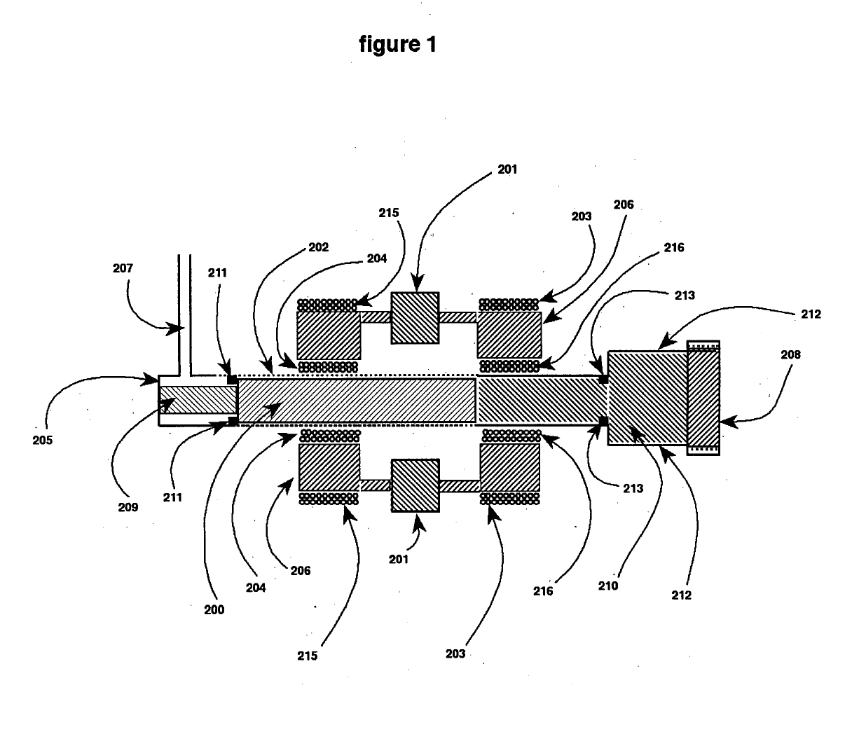

FIG. 1 shows a lateral cross-sectional view of an exemplary apparatus showing an electric current generator of the kind consisting of a system comprising a permanent magnet operating core member (200) disposed so as to couple magnetic flux from a permanently magnetically charged member (201) through a magnetically permeable coupling member assembly (206) and through critically placed coils of conductive wire (203), (204), (215), (216) as the operating core member (200) moves along an axis aligned with the magnetically permeable coupling member (206) and where the magnetic poles of the operating core member (200) are aligned axially and in opposition to the magnetic pole alignment of the permanently magnetically charged member (201), and where the operating core member is acted upon by the force of a hydraulic fluid (210) at one end and by the force from a spring assembly (209) at the other end. The apparatus includes a port end housing (212) to accumulate and control the volume of the hydraulic fluid directed to the operating core member (200), suitably located travel limit rings (211), (213) disposed to limit the mechanical travel of the core operating member (200), and a coupling (208) at the end where the hydraulic fluid (210) is present to connect to a conduit which supplies the hydraulic fluid (210). The apparatus further includes an appropriately sized and shaped chamber (205) to contain the spring assembly and the travel limit ring (211) which is disposed to limit the mechanical travel of the core operating member and where that chamber is in turn vented to the atmosphere by a tube (207) so as to allow the equalisation of pressures in the spring chamber. The apparatus further includes a centrally located chamber (202) in which the operating core member (200) moves and in which the operating core member (200) is a precision tolerance fit to minimise hydraulic fluid leakage.

The port end housing (212) of the centrally located chamber (202) is connected by means of a coupling (208) to a conduit containing a hydraulic fluid. Mechanical forces acting on the hydraulic fluid at a remote location force the fluid to move in the conduit away from the mechanical forces and the hydraulic fluid provides an input force acting directly on the operating core member. When force is applied to one end of the operating core member (200) the core member is caused to move along the centrally located chamber (202) and push against the spring member (209). As the pole faces of the operating core member (200) pass through the. magnetic flux foci between the faces of the magnetic coupling member (206), electric currents are generated in the electrically conductive windings (203), (204), (215), (216) and power may be drawn from those windings.

The permanently magnetically charged member (201) is preferably composed of an alloy of Neodymium, Iron and Boron (NdFeB) to achieve intense magnetic strength in the smallest form factor. The movable magnetic core member (200) is preferably composed of high purity solenoid grade 430F stainless steel and having a electro-deposited coating of high purity copper of 50 μm. The conductor coil windings are preferably high purity magnet winding wire composed of Copper with a purity of a minimum of 99.9% and of square cross-section to enable the highest efficiency of the generator.

Although the preferred embodiment has been illustrated, it is clear that the invention encompasses other and different arrangements within the scope of the attached claims.

While various embodiments of the present invention have been illustrated herein in detail, it should be apparent that modifications and adaptations to those embodiments may occur to those skilled in the art without departing from the scope of the present invention as set forth in the following claims.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

Additionally, throughout the specification, unless the context requires otherwise, the words “substantially” or “about” will be understood to not be limited to the value for the range qualified by the terms.

1. An apparatus for generating an electric current comprising:
a hollow chamber having a first end and a second end;
an inner core member located within the hollow chamber and movable axially along the hollow chamber;
a conductive coil arranged about the hollow chamber, and
an outer fixed magnetic structure about the hollow chamber,
wherein the first end of the hollow chamber is configured to receive fluid for acting on the core member to cause the core member to move axially along the hollow chamber thereby inducing an electric current within the conductive coil,
the inner core member is a permanent magnet,
the fixed magnetic structure comprises a permanent magnetically charged member and a magnetically permeable coupling member arranged about the hollow chamber, and
the conductive coil comprises a first conductive coil and a second conductive coil, the first conductive coil is arranged about the outer magnetic structure and the second conductive coil is arranged between the hollow chamber and the magnetically permeable couple member.

2. The apparatus according to claim 1, wherein the second end comprises a spring component for applying a restoring force to the inner core member when the inner core member is caused to move towards the second end by the fluid.

3. The apparatus according to claim 1, wherein the second end is adapted to receive fluid for acting on the inner core member to cause the inner core member to move axially along the hollow chamber thereby inducing an electric current within the conductive coil.

4. The apparatus according to claim 3, wherein the first and second ends are configured to receive the fluid alternately such that the fluid act alternately on opposing ends of the inner core member thereby causing the inner core member to move back and forth between the first and second ends of the hollow chamber.

5. The apparatus according to claim 1, wherein the first end comprises a housing for accumulating and controlling the volume of the fluid directed to the inner core member.

6. The apparatus according to claim 1, wherein the hollow member comprises a first blocking member disposed at one of the first and second ends for preventing the inner core member from moving beyond said one of the first and second ends.

7. The apparatus according to claim 6, wherein the hollow member comprises a second blocking member disposed at the other one of first and second ends for preventing the inner core member from moving beyond said other one of the first and second ends.

8. The apparatus according to claim 6, wherein the blocking member is in the form of a ring.

9. The apparatus according to claim 1, further comprising a vent in communication with the hollow chamber for equalising pressure therein with the atmosphere.

10. The apparatus according to claim 1, further comprising one or more conduits containing fluid therein, wherein said one or more conduits are in fluid communication with the first end.

11. The apparatus according to claim 3, further comprising one or more conduits containing fluid therein, wherein said one or more conduits are in fluid communication with the second end.

12. The apparatus according to claim 10, wherein said one or more conduits are resilient, and the inner core member is caused to move axially along the hollow chamber when one or more conduits are compressed at a portion thereof thereby causing fluid in said one or more conduits to flow.

13. The apparatus according to claim 12, wherein the fluid acts directly on the inner core member to cause it to move axially along the hollow chamber.

14. The apparatus according to claim 12, wherein said one or more conduits configured to be compressed by wheels of a vehicle as the vehicle travels over said one or more conduits.

15. The apparatus according to claim 1, wherein the inner core member is made of a stainless steel having a copper coating.

16. The apparatus according to claim 1, wherein the inner conductive coil is made of copper wire.

17. The apparatus according to claim 1, wherein the permanent magnetically charged member is made of a high strength magnetic alloy.

18. The apparatus according to claim 17, wherein the magnetic alloy is Neodymium, Iron and Boron (NdFeB).

19. A method of generating an electric current with an apparatus, the apparatus comprising:
a hollow chamber having a first end and a second end,
an inner core member located within the hollow chamber and movable axially along the hollow chamber,
a conductive coil arranged about the hollow chamber, and
an outer fixed magnetic structure about the hollow chamber,
the method comprising:
receiving fluid at the first end for acting on the inner core member for causing the inner core member to move axially along the hollow chamber thereby inducing an electric current within the conductive coil,
wherein the inner core member is a permanent magnet,
the fixed magnetic structure comprises a permanent magnetically charged member and a magnetically permeable coupling member arranged about the hollow chamber, and
the conductive coil comprises a first conductive coil and a second conductive coil, the first conductive coil is arranged about the outer magnetic structure and the second conductive coil is arranged between the hollow chamber and the magnetically permeable couple member.

20. The method according to claim 19, wherein the second end comprises a spring component, the method further comprising applying a restoring force to the inner core member when the inner core member is caused to move towards the second end by the fluid.

21. The method according to claim 19, further comprising receiving fluid at the second end for acting on the inner core member to cause the inner core member to move axially along the hollow chamber thereby inducing an electric current within the conductive coil.

22. The method according to claim 21, further comprising configuring the first and second ends to receive the fluid alternately such that the fluid act alternately on opposing ends of the inner core member thereby causing the inner core member to move back and forth between the first and second ends of the hollow chamber.

23. The method according to claim 19, wherein the first end comprises a housing, the method further comprising accumulating and controlling the volume of the fluid directed to the inner core member.

24. The method according to claim 19, wherein the hollow member comprises a first blocking member disposed at one of the first and second ends, the method further comprising using the first blocking member to prevent the inner core member from moving beyond said one of the first and second ends.

25. The method according to claim 24, wherein the hollow member comprises a second blocking member disposed at the other one of first and second ends, the method further comprises using the second blocking member to prevent the inner core member from moving beyond said other one of the first and second ends.

26. The method according to claim 24, wherein the blocking member is in the form of a ring.

27. The method according to claim 19, wherein the apparatus further comprises a vent in communication with the hollow chamber, the method further comprising equalising pressure in the hollow chamber with the atmosphere.

28. The method according to claim 19, further comprising arranging one or more conduits containing fluid therein to be in fluid communication with the first end.

29. The method according to claim 21, further comprising arranging one or more conduits containing fluid therein to be in fluid communication with the second end.

30. The method according to claim 28, wherein said one or more conduits are resilient, the method further comprising compressing one or more conduits at a portion thereon to cause fluid in said one or more conduits to flow thereby causing the inner core member to move axially along the hollow chamber.

31. The method according to claim 30, wherein the fluid acts directly on the inner core member to cause it to move axially along the hollow chamber.

32. The method according to claim 30, further comprising compressing said one or more conduits by wheels of a vehicle as the vehicle travels over said one or more conduits.

33. The method according to claim 19, wherein the inner core member is made of a stainless steel having a copper coating.

34. The method according to claim 19, wherein the inner conductive coil is made of copper wire.

35. The method according to claim 19, wherein the permanent magnetically charged member is made of a high strength magnetic alloy.

36. The method according to claim 35, wherein the magnetic alloy is Neodymium, Iron and Boron (NdFeB).

37. An apparatus for generating an electric current comprising:
a hollow chamber having a first end and a second end;
an inner core member located within the hollow chamber and movable axially along the hollow chamber; and
a conductive coil arranged about the hollow chamber,
wherein the first end of the hollow chamber is configured to receive fluid for acting on the core member to cause the core member to move axially along the hollow chamber thereby inducing an electric current within the conductive coil, and
the hollow member comprises a first blocking member disposed at one of the first and second ends for preventing the inner core member from moving beyond said one of the first and second ends.

38. An apparatus for generating an electric current comprising:
a hollow chamber having a first end and a second end;
an inner core member located within the hollow chamber and movable axially along the hollow chamber; and
a conductive coil arranged about the hollow chamber,
wherein the first end of the hollow chamber is configured to receive fluid for acting on the core member to cause the core member to move axially along the hollow chamber thereby inducing an electric current within the conductive coil, and
wherein the apparatus further comprises a vent in communication with the hollow chamber for equalising pressure therein with the atmosphere.

39. A method of generating an electric current with an apparatus, the apparatus comprising:
a hollow chamber having a first end and a second end,
an inner core member located within the hollow chamber and movable axially along the hollow chamber, and
a conductive coil arranged about the hollow chamber,
the method comprising:
receiving fluid at the first end for acting on the inner core member for causing the inner core member to move axially along the hollow chamber thereby inducing an electric current within the conductive coil,
wherein the hollow member comprises a first blocking member disposed at one of the first and second ends, the method further comprising using the first blocking member to prevent the inner core member from moving beyond said one of the first and second ends.

40. A method of generating an electric current with an apparatus, the apparatus comprising:
a hollow chamber having a first end and a second end,
an inner core member located within the hollow chamber and movable axially along the hollow chamber, and
a conductive coil arranged about the hollow chamber,
the method comprising:
receiving fluid at the first end for acting on the inner core member for causing the inner core member to move axially along the hollow chamber thereby inducing an electric current within the conductive coil,
wherein the apparatus further comprises a vent in communication with the hollow chamber, the method further comprising equalising pressure in the hollow chamber with the atmosphere.

41.-42. (canceled)
